(19) United States
(12) Patent Application Publication
(10) Pub. No.: US 2025/0026213 A1
(43) Pub. Date: Jan. 23, 2025

(54) METHOD FOR CONTROLLING ELECTRONIC LOCK OF SOCKET-TYPE CHARGING PILE, AND CHARGING PILE AND CHARGING APPARATUS

(71) Applicant: Autel Digital Power Co., Ltd., Shenzhen (CN)

(72) Inventor: Yunfeng XU, Shenzhen (CN)

(73) Assignee: Autel Digital Power Co., Ltd., Shenzhen, GD (CN)

(21) Appl. No.: 18/903,998

(22) Filed: Oct. 1, 2024

Related U.S. Application Data
(63) Continuation of application No. PCT/CN2023/077373, filed on Feb. 21, 2023.

(30) Foreign Application Priority Data
Apr. 1, 2022 (CN) 202210339508.9

(51) Int. Cl. B60L 53/16; B60L 53/68; H01R 13/639

(52) U.S. Cl. CPC B60L 53/16; B60L 53/68; H01R 13/639

(57) ABSTRACT

Provided is a method for controlling electronic lock of a socket-type charging pile, a charging pile and a charging apparatus. The charging pile is provided with a socket and an electronic lock is installed on the socket for locking or unlocking a charging gun. The charging gun is inserted into the socket. The charging gun and the charging pile are separate, such that a user inserts the charging gun into the charging pile when charging is required, thereby facilitating better maintenance of the charging gun.

### CROSS-REFERENCE TO RELATED APPLICATIONS

This application is a continuation application of International Patent Application No. PCT/CN2023/077373 filed on Feb. 21, 2023, which claims priority to Chinese Patent Application No. 202210339508.9, entitled “METHOD FOR CONTROLLING ELECTRONIC LOCK OF SOCKET-TYPE CHARGING PILE, CHARGING PILE AND CHARGING APPARATUS”, filed on Apr. 1, 2022, the entire disclosures of which are incorporated herein by reference for all purposes.

### TECHNICAL FIELD

The present disclosure relates to the technical field of new energy sources, and particularly relates to a method for controlling electronic lock of a socket-type charging pile, a charging pile and a charging apparatus.

### BACKGROUND

With the advent of the new energy revolution, more and more electric vehicles appear in the market, in order to meet the charging needs of electric vehicle, electric vehicle manufacturers widely distribute charging piles. A vehicle owner can use the charging gun of a charging pile to insert a charging socket of the charging gun into a charging port of an electric vehicle for charging. However, in the charging operation in the related art, the vehicle owner often encounters a lock jamming condition, which results in that the vehicle owner cannot normally charge the electric vehicle.

### SUMMARY

An object of embodiments of the present disclosure is to provide a method for controlling electronic lock of a socket-type charging pile, a charging pile and a charging apparatus for improving a lock jamming condition of the charging pile.

In a first aspect, the present disclosure provides a method for controlling electronic lock of a socket-type charging pile, including: acquiring a lock jamming command, the lock jamming command being used for indicating that an electronic lock is in a jamming state, where the charging pile is provided with a socket, an electronic lock is installed on the socket for locking or unlocking a charging gun which is inserted into the socket; and controlling the electronic lock to perform a lock jamming release operation according to the lock jamming command.

In a second aspect, embodiments of the present disclosure provide a socket-type charging pile including: a pile body; a socket installed on the pile body for inserting in a charging gun; an electronic lock installed on the socket; and a controller connected to the electronic lock for performing the above-mentioned method for controlling electronic lock of a socket-type charging pile.

In a third aspect, an embodiment of the present disclosure provides a charging apparatus, including: the socket-type charging pile; a charging gun including a gun body, a pile body plug and a vehicle plug, where the pile body plug and the vehicle plug are respectively installed on two ends of the gun body, and the electronic lock is used for locking or unlocking the pile body plug.

In a fourth aspect, embodiments of the present disclosure provide a computer-readable storage medium storing computer-executable instructions for causing an electronic device to perform the method for controlling electronic lock of a socket-type charging piles as described by any of the above.

In a fifth aspect, embodiments of the present disclosure provide a computer program product including a computer program stored on a computer readable storage medium, the computer program including program instructions which, when executed by an electronic device, cause the electronic device to perform the above-described method for controlling electronic lock of a socket-type charging pile.

In a sixth aspect, embodiments of the present disclosure provide an electronic device including: at least one processor; and a memory communicatively connected to the at least one processor. The memory stores an instruction executable by the at least one processor, and the instruction is executed by the at least one processor to enable the at least one processor to perform the method for controlling electronic lock of a socket-type charging pile.

In the method for controlling electronic lock of a socket-type charging pile provided in the embodiment of the present disclosure, on the one hand, the charging pile is provided with a socket, an electronic lock is installed on the socket for locking or unlocking a charging gun which is inserted into the socket, and the charging gun and the charging pile are separate, such that a user inserts the charging gun into the charging pile when charging is required, thereby facilitating better maintenance of the charging gun. On the other hand, according to the present embodiment, the charging pile can acquire a lock jamming command, the lock jamming command is used for indicating that the electronic lock is in a lock jamming state or an unlock jamming state, and the electronic lock is controlled to perform a lock jamming release operation according to the lock jamming command. Therefore, when the electronic lock cannot lock or unlock the charging gun, the charging pile can control the electronic lock to perform the lock jamming release operation to improve the reliability of charging.

### BRIEF DESCRIPTION OF DRAWINGS

One or more embodiments are illustrated by way of example and not by way of limitation in the figures of the accompanying drawings, in which elements having the same reference numeral designations represent similar elements, and in which the figures are not to scale unless otherwise specified.

FIG. 1 is a schematic structural diagram showing a charging apparatus according to an embodiment of the present disclosure;

FIG. 2 is a schematic structural diagram showing a charging pile as shown in FIG. 1;

FIG. 3 is a front view of a socket as shown in FIG. 2;

FIG. 4 is a schematic structural diagram showing a first circuit of an electronic lock as shown in FIG. 2;

FIG. 5 is a schematic structural diagram showing a second circuit of an electronic lock as shown in FIG. 2;

FIG. 6 is a schematic structural diagram showing a third circuit of an electronic lock as shown in FIG. 2;

FIG. 7 is a schematic diagram showing a charging scene according to an embodiment of the present disclosure;

FIG. 8 is a schematic flow chart of a method for controlling electronic lock of a socket-type charging pile according to an embodiment of the present disclosure;

FIG. 9 is a schematic flow chart showing a method for controlling electronic lock of a socket-type charging pile according to another embodiment of the present disclosure;

FIG. 10 is a schematic flow chart showing a method for controlling electronic lock of a socket-type charging pile according to another embodiment of the present disclosure;

FIG. 11 is a schematic flow chart showing a method for controlling electronic lock of a socket-type charging pile according to another embodiment of the present disclosure;

FIG. 12 is a flow chart of S89 as shown in FIG. 11;

FIG. 13 is a flow chart of S894 as shown in FIG. 12;

FIG. 14 is a schematic flow chart showing a method for controlling electronic lock of a socket-type charging pile according to another embodiment of the present disclosure; and

FIG. 15 is a schematic structural diagram showing a circuit of an electronic device according to an embodiment of the present disclosure.

### DETAILED DESCRIPTION

For the that the objects, aspects and advantages of the present disclosure may be more clearly understood, a more particular description of the invention, briefly summarized below, may be had by reference to the appended drawings and examples. It should be understood that the particular embodiments described herein are illustrative only and are not restrictive. Based on the embodiments in the present disclosure, all other embodiments obtained by a person skilled in the art without involving any inventive effort are within the scope of protection of the present disclosure.

It should be noted that, if not in conflict, the various features of the embodiments of the present disclosure may be combined with of the present disclosure. In addition, although the division of functional modules is illustrated in a schematic diagram showing an apparatus and a logical order is illustrated in a flowchart, in some cases, the steps illustrated or described may be performed in an order other than the division of the modules the apparatus or in the flowchart. Furthermore, the words “first”, “second”, “third”, and the like, as used herein do not limit the data and order of execution, but merely distinguish the same item or similar item having substantially the same function or action.

Embodiments of the present disclosure provide a charging apparatus, where the charging apparatus is adaptable to any type of electric vehicle, where the electric vehicle includes a pure electric vehicle, a hybrid electric vehicle, or an electric automobile, etc.

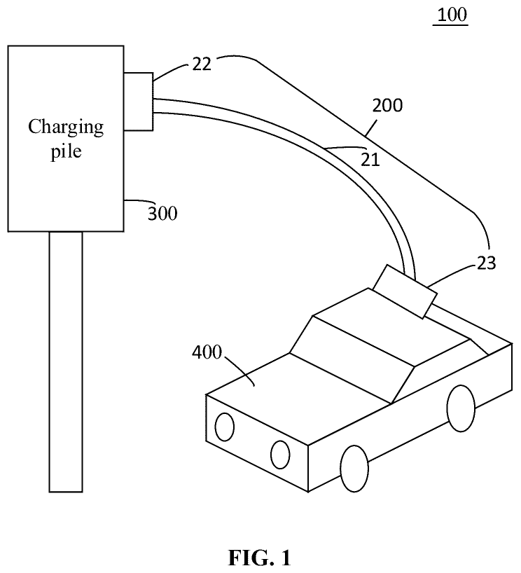

Referring to FIG. 1, the charging apparatus 100 includes a charging gun 200 and a charging pile 300, where the charging pile 300 is a socket-type charging pile, and the charging pile 300 is separated from the charging gun 200.

The charging gun 200 is used for transmitting electric energy provided by the charging pile 300 to the electric vehicle 400, where the charging gun 200 includes a gun body 21, a pile body plug 22 and a vehicle plug 23, where the pile body plug 22 and the vehicle plug 23 are respectively installed at two ends of the gun body 21.

The gun body 21 has a strip shape, and is provided with an accommodating cavity therein for accommodating each power cable.

An outer surface of the pile body plug 22 is provided with an insertion hole, and when it is necessary to fix the charging gun 200 to the charging pile 300, an electronic lock of the charging pile 300 is inserted into the insertion hole, so that the charging gun 200 can be locked. When it is desired to remove the charging gun 200 from the charging pile 300, the electronic lock of the charging pile 300 is removed from the insertion hole so that the charging gun 200 can be released.

The vehicle plug 23 is used to plug into the vehicle charging plug of the electric vehicle 400, and the electric energy of the charging pile 300 is applied to the vehicle charging plug through the pile body plug 22 of the charging gun 200, the power cable of the gun body 21 and the vehicle plug 223 to supply the electric vehicle 400 with electric energy.

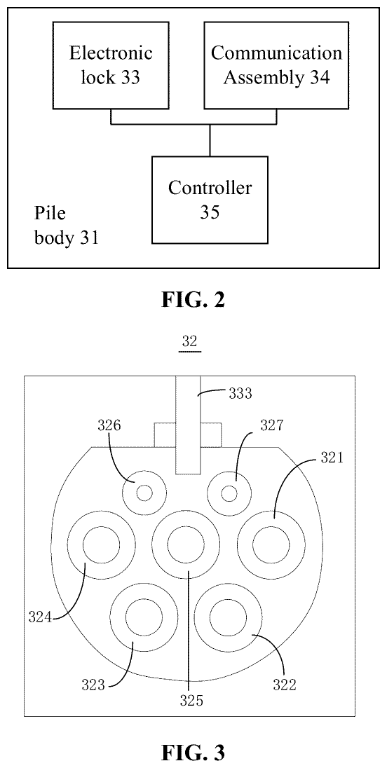

The charging pile 300 is used for supplying power to the electric vehicle 400 through the charging gun 200, where referring to FIGS. 2 and 3, the charging pile 300 includes a pile body 31, a socket 32, an electronic lock 33, a communication assembly 34 and a controller 35.

The pile body 31 is installed on the ground for carrying various components. The pile body 31 may be constructed of any suitable material.

The socket 32 is installed on the pile body 31 for inserting the charging gun 200. The socket 32 includes a first phase power terminal 321, a second phase power terminal 322, a third phase power terminal 323, a neutral terminal 324, a ground terminal 325, a handshake terminal 326, and a control terminal 327.

The first phase power terminal 321, the second phase power terminal 322, the third phase power terminal 323, and the neutral terminal 324 are used to collectively boost the three-phase power. The ground terminal 325 is used for grounding.

The handshake terminal 326 is used for transmitting a handshake signal for confirming whether the handshake between the charging pile 300 and the charging gun 200 is successful, and when the handshake signal is a first-type handshake signal, the charging pile 300 confirms that the handshake between the charging gun 200 is successful, i.e., when the charging gun 200 is correctly inserted in the socket 32, the charging gun 200 sends the first-type handshake signal to the charging pile 300, or the charging pile 300 can generate the first-type handshake signal.

When the handshake signal is a second type handshake signal, then the charging pile 300 confirms that it has not had a handshake with the charging gun 200, i.e., the charging gun 200 has not been correctly inserted into the socket 32, the charging pile 300 is able to generate the second type handshake signal.

In some embodiments, the first type handshake signal is high level and the second type handshake signal is low level, or the first type handshake signal is low level and the second type handshake signal is high level.

It will be appreciated that the number of contacts and placement of the sockets 32 are adapted to the pile body plug 22 and the vehicle plug 23, respectively.

The control terminal 327 is used to transmit a control signal, where the control signal is a signal satisfying a charging pile protocol, and the charging pile 300 is in interactive communication with the charging gun 200 based on the control signal transmitted by the control terminal 327.

The electronic lock 33 is installed on the socket 32 and is electrically connected to the controller 35 for locking or unlocking the pile body plug. For example, the electronic lock 33 is controlled by the controller 35 to lock or unlock the charging gun 200 inserted into the socket 32. When it is required to fix the charging gun 200 to the charging pile 300, the electronic lock 33 performs a locking operation, i.e., the electronic lock 33 is inserted into the insertion hole of the pile body plug 22. When it is desired to remove the charging gun 200 from the charging pile 300, the electronic lock 33 performs an unlocking operation, i.e., the electronic lock 33 is removed from the insertion hole of the pile body plug 22.

Referring to FIG. 4, the electronic lock 33 includes a motor 331, a transmission mechanism 332, and a locking member 333.

The motor 331 is electrically connected to the controller 35 for entering a corresponding operation state in response to a control command sent by the controller 35, where the operation state includes an unlocking operation state, a locking operation state and a lock jamming release operation state, and when the control command is an unlock jamming command, the controller 35 can control the motor 331 to enter the unlocking operation state. When the control command is a lock command, the controller 35 can control the motor 331 to enter a locking operation state. When the control command is a lock jamming command, the controller 35 can control the motor 331 to enter a lock jamming release operation state.

In some embodiments, the motor 331 may be a stepper motor, a servo motor or the like.

The transmission mechanism 332 is connected to the motor 331 for being driven by the motor 331 to perform transmission work, where the transmission mechanism 332 includes a screw rod and a screw sleeve, the screw rod is connected to an output shaft of the motor 331, the screw sleeve is sleeved in the screw rod, the motor 331 is controlled by the controller 35 to drive the screw rod to rotate, and the screw rod drives the screw sleeve to be movable on the screw rod.

It is to be understood that the transmission mechanism 332 may include other suitable components in addition to the above-mentioned components, for example, the transmission mechanism 332 includes a gear transmission mechanism and a connecting rod transmission mechanism, the motor 331 is connected to the gear transmission mechanism, the gear transmission mechanism is connected to the connecting rod transmission mechanism, and the motor 331 is controlled by the controller 35 and drives the gear transmission mechanism to drive the connecting rod transmission mechanism to move.

The locking member 333 is connected to the transmission mechanism 332, and the transmission mechanism 332 can drive the locking member 333 to lock or unlock the charging gun 200, for example, when the locking operation is performed, the transmission mechanism 332 drives the locking member 333 to be inserted into the insertion hole of the pile body plug 22 to unlock the charging gun 200. When the unlocking operation is performed, the transmission mechanism 332 drives the locking member 333 out of the insertion hole of the pile body plug 22 to unlock the charging gun 200.

The working principle of the electronic lock 33 performing the unlocking operation and the locking operation is described below, and the details are as follows:
the controller 35 controls the motor 331 to enter the locking operation state according to the lock command, and the motor 331 drives the transmission mechanism 332 to move the locking member 333 toward the insertion hole of the charging gun 200 until the locking member 333 is inserted into the insertion hole, thereby completing the locking operation.

The controller 35 controls the motor 331 to enter the unlocking operation state according to the unlock jamming command, and the motor 331 drives the transmission mechanism 332 to move the locking member 333 in a direction away from the insertion hole of the charging gun 200 until the locking member 333 moves out of the insertion hole, thereby completing the unlocking operation.

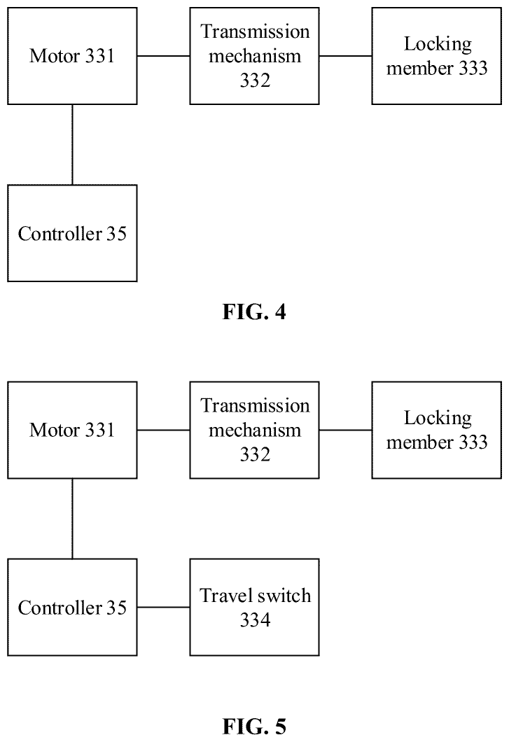

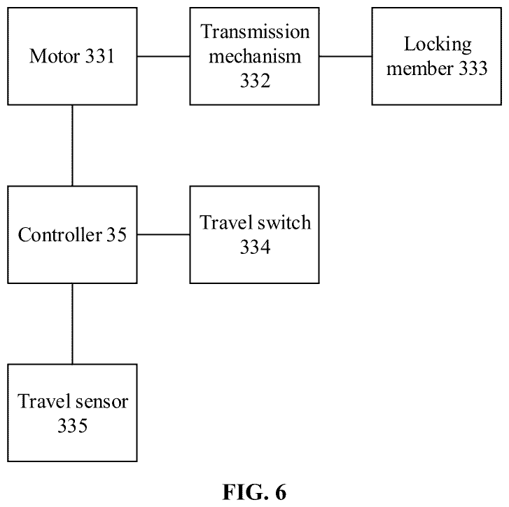

In some embodiments, referring to FIG. 5, the electronic lock 33 further includes a travel switch 334 provided within the electronic lock 33 and electrically connected to the controller 35 for generating a position signal to detect the position of the locking member 333.

In some embodiments, the number of travel switches 334 is at least two, with a first travel switch provided at a tongue start position of the electronic lock and a second travel switch provided at a tongue end position of the electronic lock, where the tongue start position is defined as a start point at which the locking member 333 begins to perform a locking operation, and the tongue end position is defined as a start point at which the locking member 333 begins to perform an unlocking operation.

When the motor enters the locking operation state, the transmission mechanism can be driven to drive the locking member 333 to move from the tongue start position, and when the position of the locking member 333 reaches the tongue end position, the second travel switch generates a high-level position signal, where the high-level position signal is used for indicating that the locking member 333 has moved into the insertion hole of the charging gun 200, i.e., the locking operation is completed.

When the motor enters the locking operation state, if the controller 35 does not detect the high level of the second travel switch, the controller 35 determines that the locking operation has not been completed.

When the motor enters the unlocking operation state, the transmission mechanism can be driven to drive the locking member 333 to move from the tongue end position, and when the position of the locking member 333 reaches the tongue start position, the first travel switch generates a high-level position signal, where the high-level position signal is used for indicating that the locking member 333 has moved into the insertion hole of the charging gun 200, i.e., the locking operation is completed.

When the motor enters the unlocking operation state, if the controller 35 does not detect the high level of the first travel switch, the controller 35 determines that the unlocking operation has not been completed.

In some embodiments, referring to FIG. 6, the electronic lock 33 further includes a travel sensor 335 installed within the electronic lock 33. The travel sensor 335 is connected to the controller 35 for detecting the moving distance of the locking member 333.

In some embodiments, the travel sensor 335 includes a magnet and a Hall sensor, the magnet being fixed at a first designated position of the locking member 33 for radiating a magnetic field signal, where the first designated position may be a side of the locking member 33 away from the motor 331 or a side of the locking member 33 proximate to the motor 331. The Hall sensor is fixed at a second designated position within the electronic lock 33, which may be the position of the motor 331 or another position of the electronic lock 33, and is in communication with the controller 35 for sensing a magnetic field signal to obtain a magnetic field strength. The distance between the magnet and the Hall sensor changes monotonically with the magnetic field strength, for example, the larger the distance between the magnet and the Hall sensor, the smaller the magnetic field strength, and the smaller the distance between the magnet and the Hall sensor, the larger the magnetic field strength, and therefore, the controller 35 determines the moving distance of the locking member 333 according to the magnetic field strength.

In some embodiments, the travel sensor 335 includes an infrared transmitter fixed at a first designated position on the locking member 33 and coupled to the controller 35 for transmitting an infrared signal and an infrared receiver. The infrared receiver is fixed at a second designated position within the electronic lock 33 and is in communication with the controller 35 for receiving infrared signals for signal strength. The greater the distance between the locking member 33 and the motor 331, the smaller the signal strength, and the smaller the distance between the locking member 33 and the motor 331, the greater the signal strength, so the controller 35 determines the moving distance of the locking member 333 according to the signal strength.

It can be appreciated that the distance measurement principle of the travel sensor 335 is rather cumbersome, and a person skilled in the art would have been able to select an appropriate type of the travel sensor on his own initiative according to service requirements.

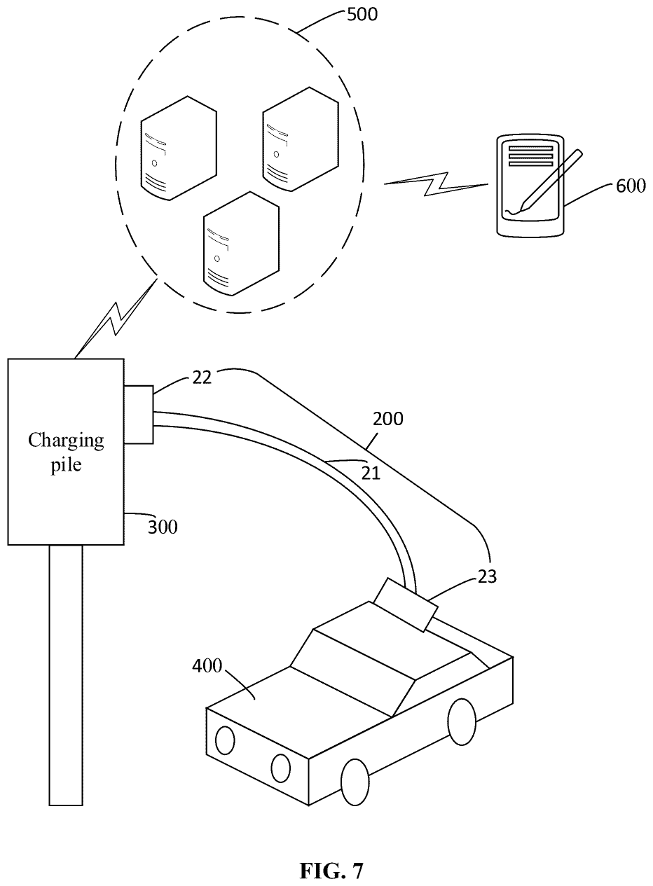

The communication assembly 34 is connected to the controller 35 for communicating with an external device, where the external device may be a cloud server and/or a mobile terminal. Referring to FIG. 7, the external devices are a cloud server 500 and a mobile terminal 600, respectively.

The cloud server 500 communicates with the charging pile 300 via the communication assembly 34, for example, the cloud server 500 can send charging configuration information to the charging pile 300, and the charging configuration information is used for configuring corresponding working parameters of the charging pile 300, for example, the charging pile 300 updates a power monitoring threshold according to the charging configuration information, and the power monitoring threshold is used for the charging pile 300 to monitor whether the output power is excessive to ensure the security of the charging pile 300 when charging. For another example, the charging pile 300 can send working parameter information to the cloud server 500, and the cloud server 500 parses the working parameter information and judges the operation condition of the charging pile 300 according to the parsing result to effectively maintain the charging pile 300.

The mobile terminal 600 can communicate with the cloud server 500, and issues a control command to the charging pile 300 via the cloud server 500; for example, the mobile terminal 600 sends a lock jamming failure request to the cloud server 500, where the lock jamming failure request carries a pile body identifier of the charging pile; the cloud server 500 sends a lock jamming command to the charging pile corresponding to the pile body identifier according to the lock jamming failure request; and the controller 35 of the charging pile receives the lock jamming command via the communication assembly 34, and controls the electronic lock 33 to perform a lock jamming release operation according to the lock jamming command.

The controller 35 acts as a control core for the charging pile 300, where the controller 35 may be a general-purpose processor, a digital signal processor, an application specific integrated circuit, a field programmable gate array, a single chip microcomputer, a ARM or other programmable logic device, discrete gate or transistor logic, discrete hardware components, or any combination of these components. Also, the controller 35 may be any conventional processor, controller, microcontroller, or state machine. The controller 35 may also be implemented as a combination of computing devices, e.g., a combination of a DSP and a microprocessor, a plurality of microprocessors, one or more microprocessors in conjunction with a DSP core, or any other such configuration.

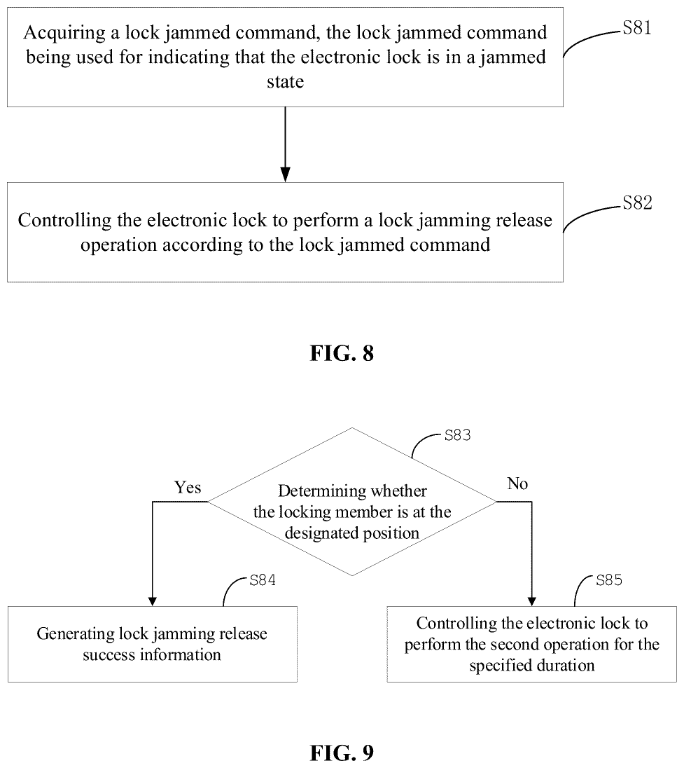

As another aspect of the embodiments of the present disclosure, the embodiments of the present disclosure provide a method for controlling electronic lock of a socket-type charging pile, and it can be understood that the executive body of the method for controlling electronic lock of a socket-type charging pile can be a charging pile, and can also be other devices having a logical operation function and an analysis function, for example, the devices are cloud servers, etc. Referring to FIG. 8, the method for controlling electronic lock of a socket-type charging pile includes:
S81: acquiring a lock jamming command, the lock jamming command being used for indicating that the electronic lock is in a jamming state.

In this step, the jamming state includes a lock jamming state or an unlock jamming state, where the lock jamming state is a state trapped in the jamming state when the electronic lock performs the locking operation, and the unlock jamming state is a state trapped in the jamming state when the electronic lock performs the unlocking operation.

For example, since the charging pile is installed on the ground outdoors, the electronic lock thereof is liable to rust. Alternatively, the insertion hole of the charging gun of the user is used for too long or improperly maintained, resulting in deformation or rusting of the insertion hole. When the electronic lock performs the locking operation, the locking member is caught inside the electronic lock without being partially or fully inserted into the insertion hole, i.e., the locking member is not able to protrude to the tongue end position, so that the electronic lock is in a lock jamming state.

When the electronic lock performs the unlocking operation, the locking member is jammed at the outside of the electronic lock and cannot be partially or fully retracted into the electronic lock, that is, the locking member cannot be retracted to the tongue start position, and therefore, the electronic lock is in the unlock jamming state.

In this step, the lock jamming command includes a lock and unlock jamming command, and when the electronic lock is in the unlock jamming state, the lock jamming command is an unlock jamming command. When the electronic lock is in the unlock jamming state, the lock jamming command is an unlock jamming command.

In some embodiments, when acquiring the lock jamming command, S81 includes: when it is detected that the electronic lock performs a locking operation, marking a locking start time point, and determining whether the duration between the current time point and the locking start time point is greater than or equal to a standard duration; when it is greater than or equal to the standard duration, determining that the electronic lock is in a lock jamming state, and generating a lock jamming command. When it is less than the standard duration, returning to the step of determining whether the duration between the current time point and the locking start time point is greater than or equal to the standard duration.

In some embodiments, when acquiring the lock jamming command, S81 includes: when it is detected that the electronic lock performs an unlocking operation, marking an unlocking start time point, and determining whether the duration between the current time point and the unlocking start time point is greater than or equal to a standard duration; when it is greater than or equal to the standard duration, determining that the electronic lock is in an unlock jamming state, and generating an unlock jamming command. When it is less than the standard duration, returning to the step of determining whether the duration between the current time point and the unlocking start time point is greater than or equal to the standard duration.

The present embodiment provides the charging pile capable of automatically monitoring whether the electronic lock is in the lock jamming state or the unlock jamming state to generate the lock jamming command or the unlock jamming command, thereby enabling the charging pile to intelligently solve the lock jamming release problem.

In some embodiments, the pie bodies of the charging piles are provided with a lock jamming button for generating a lock jamming command in response to a user's pressing operation and an unlock jamming button for generating an unlock jamming command in response to a user's pressing operation. When acquiring the lock jamming command, S81 includes: polling the lock jamming or unlock jamming button at a pre-set frequency to obtain a lock jamming command.

In some embodiments, a mobile terminal logs in a charging application APP, and clicks a fault UI button on the charging application APP to prompt the mobile terminal to send a lock jamming fault request to a cloud server, where the lock jamming fault request carries a pile body identifier of a charging pile, and the cloud server sends a lock jamming trigger command to a charging pile corresponding to the pile body identifier according to the lock jamming fault request; therefore, when acquiring the lock jamming command, S81 includes: a lock jamming trigger sent by the cloud server is acquired, a charging state of the electric vehicle is determined according to the lock jamming trigger command, and an unlock jamming command is generated if the charging state is a charging end state. If the charging state is a charge start state, a lock jamming command is generated.

When a user finds that an electronic lock cannot normally perform a locking operation or an unlocking operation during the charging process, a charging application APP of a mobile terminal (such as a mobile phone) is operated to send a lock jamming command to a charging pile via a cloud server to prompt the charging pile to solve the locking jamming release problem in time.

In some embodiments, when it is detected that the electronic lock is in a lock jamming state, the lock jamming auxiliary information is presented, and the lock jamming auxiliary information is used for prompting the user to insert the charging gun into the charging pile, for example, the charging pile is provided with a display screen, and the display screen presents the lock jamming auxiliary information, where the lock jamming auxiliary information is “the electronic lock is jammed, please insert the pile body plug of the charging gun”, and thus, after the user inserts the pile body plug of the charging gun according to the lock jamming auxiliary information, the charging pile can control the electronic lock to perform a lock jamming release operation more effectively to improve the lock jamming release efficiency.
S82: controlling the electronic lock to perform a lock jamming release operation according to the lock jamming command.

In this step, the lock jamming release operation is an operation for releasing the electronic lock from a lock jamming state, where the lock jamming release operation includes a lock jamming release operation and an unlock jamming release operation, where the lock jamming release operation is an operation for releasing the electronic lock from a lock jamming state, and the unlock jamming release operation is an operation for releasing the electronic lock from an unlock jamming state.

In some embodiments, the charging pile controls the electronic lock to perform a lock jamming release operation when the lock jamming command is a lock jamming release command. The charging pile controls the electronic lock to perform the unlock jamming release operation when the lock jamming command is the unlock jamming command.

In the present embodiment, on one hand, the charging pile is provided with a socket, an electronic lock is installed on the socket for locking or unlocking a charging gun which is inserted into the socket, and the charging gun and the charging pile provided by the present embodiment are separate, such that a user inserts the charging gun into the charging pile when charging is required, thereby facilitating better maintenance of the charging gun. On the other hand, according to the present embodiment, the charging pile can acquire a lock jamming command, the lock jamming command is used for indicating that the electronic lock is in a lock jamming state or an unlock jamming state, and the electronic lock is controlled to perform a lock jamming release operation according to the lock jamming command. Therefore, when the electronic lock cannot lock or unlock the charging gun, the charging pile can control the electronic lock to perform the lock jamming release operation to improve the reliability of charging.

In some embodiments, the charging pile can control the electronic lock to alternately perform the first operation and the second operation according to a pre-set number of cycles according to a lock jamming command. When the electronic lock is in a lock jamming state, the first operation is an unlocking operation, and the second operation is a locking operation, that is to say, when the lock jamming command is a lock jamming command, the charging pile controls the electronic lock to alternately perform the unlocking operation and the locking operation according to a pre-set number of cycles. When the electronic lock is in an unlock jamming state, the first operation is a locking operation, and the second operation is an unlocking operation, i.e., when the lock jamming command is an unlock jamming command, the charging pile controls the electronic lock to alternately perform the locking operation and unlocking operation according to a pre-set number of cycles.

For example, when the electronic lock is in the lock jamming state, referring to FIG. 4, the controller 35 controls the motor 331 to drive the transmission mechanism 332 to move the locking member 333 in a direction away from the insertion hole at a normal speed for 2 seconds to complete the unlocking operation. Then, the controller 35 controls the motor 331 to drive the transmission mechanism 332 to move the locking member 333 in a direction close to the insertion hole at a normal speed for 2 seconds to complete the locking operation. The above-mentioned process of unlocking operation and locking operation is a locking and unlocking process of one cycle. Assuming that the pre-set number of cycles is 5, the controller 35 controls the motor 331 to drive the transmission mechanism 332 to drive the locking member 333 to perform the unlocking operation and the locking operation for five times.

When the electronic lock is in the unlock jamming state, in conjunction with FIG. 4, the controller 35 controls the motor 331 to drive the transmission mechanism 332 to move the locking member 333 in the direction close to the insertion hole according to the normal speed for 2 seconds to complete the locking operation. Then, the controller 35 controls the motor 331 to drive the transmission mechanism 332 to move the locking member 333 in a direction away from the insertion hole at a normal speed for 2 seconds to complete the unlocking operation. The process of the locking and unlocking operations is a locking and unlocking process of one cycle.

It is to be understood that the pre-set number of cycles provided above is 2, and in some embodiments, the pre-set number of cycles may be 1 or 5 or 10, etc.

As described above, when the present embodiment performs the lock jamming release operation, by alternately performing the first operation and the second operation according to the pre-set number of cycles, i.e., controlling the locking member to move back and forth, on the one hand, this method can not only vibrate the electronic lock to shake out the jams existing in the electronic lock itself, but also shake out the jams between the locking member and the insertion hole of the electronic lock, thereby increasing the probability of success in releasing the lock jamming.

In some embodiments, each time the charging pile controls the electronic lock to alternately perform the first operation and the second operation, it is determined whether the locking member is at the designated position, where the designated position is the tongue end position when the electronic lock is in the lock jamming state. When the electronic lock is in an unlock jamming state, the designated position is the tongue start position. When the locking member is at the designated position, it is determined that the lock jamming release operation has been performed. When the locking member is not at the designated position, it is determined that the lock jamming release operation has not been completed, and a first operation of a first duration and a second operation of a second duration are continued to be performed for the next number of cycles.

In some embodiments, the locking member can perform a first operation and a second operation at the same speed, and the charging pile can control the electronic lock to alternately perform the first operation for a first duration and the second operation for a second duration according to a pre-set number of cycles according to the lock jamming command.

In some embodiments, the first duration is equal to the second duration when the electronic lock is in the lock jamming state or the unlock jamming state, i.e., the locking member alternately performs the first operation and the second operation for the same duration regardless of the jamming state of the electronic lock.

In some embodiments, the first duration of the unlocking operation is less than the second duration of the locking operation when the electronic lock is in the lock jamming state, i.e., in the present embodiment, the locking member can also be moved to the designated position as soon as possible during the shock of the back and forth movement of the locking member plus the rolling action of the plurality of cyclic movements when the electronic lock is in the lock jamming state to achieve the locking purpose as soon as possible, further enabling the charging pile to supply power to the electric vehicle as soon as possible.

In some embodiments, the first duration of the locking operation is less than the second duration of the unlocking operation when the electronic lock is in the unlock jamming state, i.e., in the present embodiment, the locking member can also move to the designated position as soon as possible during the shock of the back and forth movement of the locking member plus the rolling action of the plurality of cyclic movements when the electronic lock is in the unlock jamming state to achieve the unlocking purpose as soon as possible, further enabling the user to take out the charging gun from the charging pile as soon as possible.

In some embodiments, the first duration and the second duration may be customized by the designer based on engineering experience, such as the first duration being T/10, the second duration being T/5, T being a standard duration, and the standard duration being a duration required for the electronic lock to normally lock or unlock the charging gun.

In some embodiments, after performing the lock jamming release operation, referring to FIG. 9, the method for controlling electronic lock of a socket-type charging pile further includes:
S83: determining whether the locking member is at the designated position.
S84: when at the designated position, generating lock jamming release success information.
S85: when not at the designated position, controlling the electronic lock to perform a second operation for a specified duration.

In S83, when the electronic lock is in the lock jamming state, the designated position is the tongue end position. When the electronic lock is in an unlock jamming state, the designated position is the tongue start position.

In some embodiments, referring to FIG. 5, S83 includes: when it is detected that the electronic lock performs a locking operation, acquiring a position signal sent by the second travel switch, and when the position signal is a high level, determining that the locking member is at the designated position, and when the position signal is a low level, determining that the locking member is not at the designated position.

In some embodiments, referring to FIG. 5, S83 includes: when it is detected that the electronic lock performs an unlocking operation, acquiring a position signal sent by the first travel switch, and when the position signal is a high level, determining that the locking member is at the designated position, and when the position signal is a low level, determining that the locking member is not at the designated position.

In some embodiments, referring to FIG. 6, S83 includes: when it is detected that the electronic lock performs an unlocking operation or a locking operation, determining a moving distance of a locking member, when the moving distance is equal to a standard distance, determining that the locking member is at the designated position, and when the moving distance is less than the standard distance, determining that the locking member is not at the designated position, the standard distance being a distance required when the locking member is inserted in a insertion hole.

In some embodiments, it is determined that the moving distance of the locking member includes: the magnetic field strength is acquired, and the moving distance of the locking member is calculated according to the relationship between the magnetic field strength and the distance.

In some embodiments, the moving distance of the locking member is determined to include: the signal intensity of the infrared signal is acquired, and according to the relationship between the signal intensity of the infrared signal and the distance, the infrared signal and the distance is calculated.

In S84, when the locking member is at the designated position, it is indicated that the electronic lock has been released from the jamming state, and therefore, the charging pile generates lock jamming release information, where the lock release success information is information indicating that the electronic lock has been released from the jamming state.

In some embodiments, the lock jamming release success information is voice information, and the charging pile plays the lock jamming release success information, or the charging pile sends the lock jamming release success information to the cloud server, and the cloud server forwards the lock jamming release success information to the mobile terminal, and the mobile terminal plays the lock jamming release success information.

In some embodiments, the lock jamming release success information is text information, the charging pile presents the lock jamming release success information via a display screen, or the charging pile sends the lock jamming release success information to the cloud server which forwards the lock jamming release success information to the mobile terminal, and the mobile terminal presents the lock jamming release success information.

In S85, since the locking member is not at the designated position, it is indicated that the electronic lock has not been released from the jamming state, and therefore, the charging pile needs to perform a second operation for a specified duration, where the standard duration is greater than or equal to a standard duration required for the electronic lock to normally lock or unlock the charging gun, that is, the standard duration required for the locking member to normally lock or unlock the charging gun. As previously described, the second operation is a locking operation when the electronic lock is in the lock jamming state. The second operation is an unlocking operation when the electronic lock is in the unlock jamming state.

As described above, the charging pile controls the electronic lock to perform the lock jamming release operation according to the lock jamming command. Each time a lock jamming release operation is performed, a first duration when the locking member performs a first operation at the same speed is less than a second duration when a second operation is performed, i.e., a moving distance when the locking member performs the first operation is less than a moving distance when the second operation is performed, for example, when the electronic lock is in a lock jamming state, the moving distance of the locking operation is greater than the moving distance of the unlocking operation, or when the electronic lock is in an unlock jamming state, the moving distance of the unlocking operation is greater than the moving distance of the locking operation; therefore, after the electronic lock performs the lock jamming release operation, it may occur that the locking member is already at the designated position in advance, and therefore, the present embodiment needs to determine whether the locking member is at the designated position after the lock jamming release operation is performed in order to ensure that the unlocking or locking is performed quickly.

When the locking member is not at the designated position, the charging pile controls the electronic lock to perform a second operation for a specified duration; as shown in FIG. 5, the electronic lock can only know whether the locking member is in the tongue start position or in the tongue end position; in order to be able to reliably detect whether the locking member is in the tongue start position or in the tongue end position, it can be determined by whether the specified duration is greater than or equal to a standard duration; and this would make the electronic lock not need to be provided with a sensor with rich functions and high cost, which is beneficial to reduce the structural design cost and design difficulty of the electronic lock.

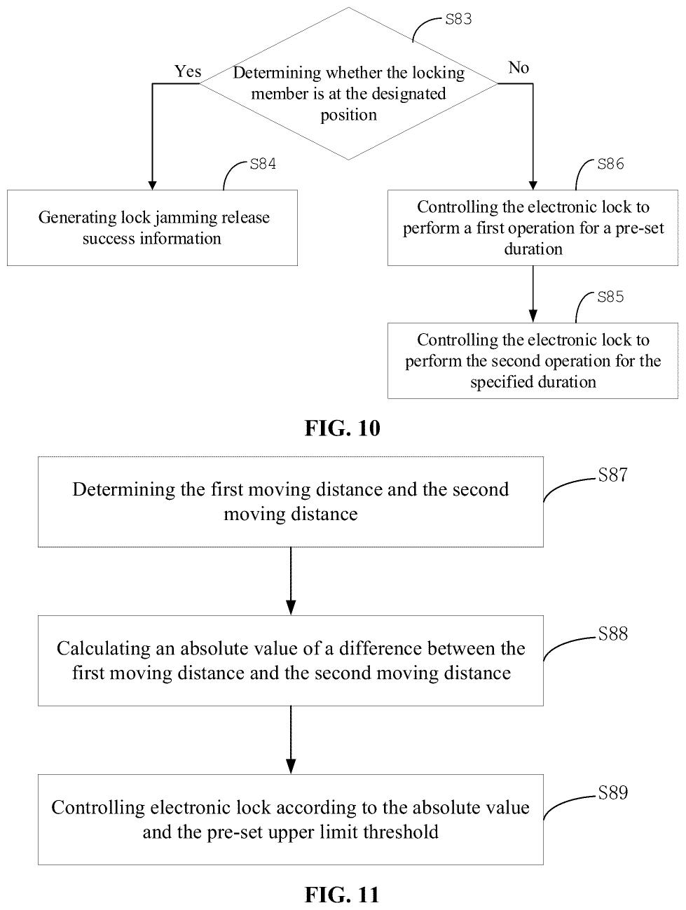

In some embodiments, when not at the designated position, prior to performing the second operation for the specified duration, referring to FIG. 10, the electronic-lock control method further includes S86: the electronic lock is controlled to perform a first operation for a pre-set duration. The pre-set duration can be defined by the designer based on engineering experience, for example, the pre-set duration is T/2.

As previously described, the first operation is an unlocking operation when the electronic lock is in the lock jamming state. The first operation is a locking operation when the electronic lock is in an unlock jamming state.

In the present embodiment, after the charging pile controls the electronic lock to alternately perform the first operation and the second operation according to the pre-set number of cycles, if the locking member is not at the designated position, the charging pile controls the electronic lock to perform the first operation for a pre-set duration, where, if the electronic lock is in a lock jamming state, the charging pile controls the electronic lock to perform the unlocking operation for the pre-set duration. If the electronic lock is in an unlock jamming state, the charging pile controls the electronic lock to perform a locking operation for a pre-set duration. This is to make full use of the system inertia of the electronic lock to improve the probability of releasing the jamming state when a second operation of a specified duration is subsequently performed.

A first operation of a pre-set duration is performed, and the charging pile controls the electronic lock to perform a second operation of a specified duration, where if the electronic lock is in a lock jamming state, the charging pile controls the electronic lock to perform a locking operation of the specified duration. If the electronic lock is in an unlock jamming state, the charging pile controls the electronic lock to perform an unlocking operation for a pre-set duration. The present embodiment can effectively cancel the jamming state of the electronic lock using the run-up travel formed by performing the first operation for a pre-set duration, using the second operation for a specified duration, using the run-up travel, and using the system inertia of the electronic lock.

In some embodiments, the present embodiment is different from the above-described embodiments in that the present embodiment is capable of detecting the moving distance of the locking member using the travel sensor, and controlling the electronic lock to perform corresponding operation according to the moving distance of the locking member. Referring to FIG. 11, the electronic-lock control method includes:
S87: determining the first moving distance and the second moving distance.
S88: calculating an absolute value of a difference between the first moving distance and the second moving distance.
S89: controlling the electronic lock according to the absolute value and the pre-set upper limit threshold.

In S87, the first moving distance is a moving distance of the locking member before the first operation is performed for the first time, and the second moving distance is a moving distance of the locking member after the second operation is performed for the last time.

In some embodiments, referring to FIG. 6, S87 includes: prior to performing the first operation for the first time, the magnetic field strength is acquired, and the moving distance of the locking member is calculated according to the relationship between the magnetic field strength and the distance. S87 includes: after the last second operation is performed, acquiring the magnetic field strength, and calculating the moving distance of the locking member according to the relationship between the magnetic field strength and the distance.

In some embodiments, referring to FIG. 6, S87 includes: before performing the first operation for the first time, acquiring a first signal strength of the infrared signal, and calculating a first moving distance of the locking member according to a relationship between the first signal strength and the distance. S87 includes: after the last second operation is performed, acquiring a second signal intensity of the infrared signal, and acquiring a second moving distance of the locking member according to the relationship between the second signal intensity and the distance.

As previously described, the charging pile controls the electronic lock to alternately perform the first operation and the second operation according to a pre-set number of cycles according to the lock jamming command.

When the pre-set number of cycles is 1, for example, the time axis includes a time point t0, a time point t1 and a time point t2, where between t0 and t1 is a duration Δt10 of a first operation, and between t1 and t2 is a duration Δt21 of a second operation, where Δt21 is greater than Δt10. Since the time point t0 is a time point before performing the first operation for the first time, the first moving distance is a moving distance of the locking member at the time point t0. Since the time point t2 is a time point before the last second operation is performed, the second moving distance is a moving distance of the locking member at the time point t2.

When the pre-set number of cycles is greater than or equal to 2, for example, assuming that the pre-set number of cycles is 2, the time axis includes a time point t0, a time point t1, a time point t2, a time point t3, and a time point t4. Between t0 and t1 is a duration Δt10 of a first operation, and between t1 and t2 is a duration Δt21 of a second operation, where Δt21 is greater than Δt10, where t0 to t2 are time processes of a first number of cycles. By the same reasoning, between t2 and t3 is a duration Δt32 of a first operation, between t3 and t4 is a duration Δt43 of a second operation, and Δt43 is greater than Δt32, where t2 to t4 are time processes of a second number of cycles.

Since the time point t0 is a time point before performing the first operation for the first time, the first moving distance is a moving distance of the locking member at the time point t0. Since the time point t4 is a time point before the last second operation is performed, the second moving distance is a moving distance of the locking member at the time point t4.

In S88, in some embodiments, S88 includes: subtracting the first moving distance from the second moving distance to obtain a difference, and taking the absolute value of the difference.

In S89, the pre-set upper limit threshold is a threshold for indicating whether the electronic lock has been released from the jamming state after performing the lock jamming release operation, where the pre-set upper limit threshold may be customized by a user, such as 2 cm or 3 cm, etc.

Since the present embodiment controls the electronic lock by detecting the moving distance of the locking member and based on the absolute value and the pre-set upper limit threshold, the present embodiment can detect whether the electronic lock has been released from the jamming state more accurately and reliably.

In some embodiments, when the lock jamming release operation is performed, the first duration of the first operation is: t_{_p1}=T_{_p1}/N, the second duration of the second operation is: t_{_p2}=T_{_p2}/N, T_{_p1} is less than T_{_p2}, T_{_p1} and T_{_p2} are pre-set time, and N is the pre-set number of cycles. As previously described, when the charging pile controls the electronic lock to alternately perform the first operation and the second operation according to the pre-set number of cycles, the total duration of the first operation is 5*t_{_p1}=5*T_{_p1}/5=T_{_p1}, and the total duration of the second operation is 5*t_{_p2}=5*T_{_p2}/5=T_{_p2}. Since T_{_p1} is smaller than T_{_p2}, after the lock jamming release operation is performed, the distance of the first operation is smaller than the distance of the second operation, facilitating the movement of the locking member to the designated position when the lock jamming release operation is performed.

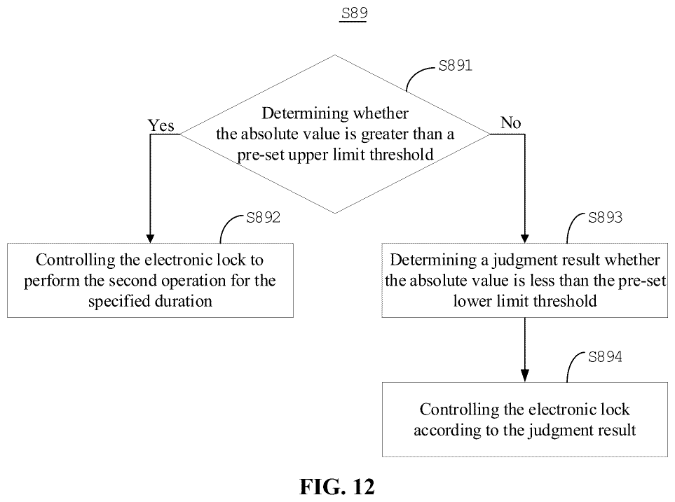

In some embodiments, when controlling the electronic lock based on the absolute value and the pre-set upper limit threshold, referring to FIG. 12, S89 includes:
S891: determining whether the absolute value is greater than a pre-set upper limit threshold.
S892: when the absolute value is greater than a pre-set upper limit threshold, controlling the electronic lock to perform a second operation for a specified duration.
S893: when the absolute value is not greater than the pre-set upper limit threshold, determining the judgment result whether the absolute value is less than the pre-set lower limit threshold.
S894: controlling the electronic lock according to the judgment result.

In S891, the absolute value may be less than or equal to the pre-set upper limit threshold, or the absolute value may be greater than the pre-set upper limit threshold.

In S892, when the absolute value is greater than the pre-set upper limit threshold, it is indicated that a relatively large movement can be performed in the process of the electronic lock performing the lock jamming release operation, and it is also indicated that the electronic lock has been released from the jammed state after performing the lock jamming release operation; therefore, the charging pile needs to control the electronic lock to perform a second operation for a specified duration, for example, when the electronic lock is in the lock jamming state, after the electronic lock has performed the locking operation for a pre-set number of cycles in the lock jamming release operation, the electronic lock then continues to perform the locking operation for a specified duration. Alternatively, when the electronic lock is in the unlock jamming state, the electronic lock continues to perform the unlocking operation for a specified duration after the electronic lock performs the unlocking operation for a pre-set number of cycles in the lock jamming release operation.

In S893 and S894, the pre-set lower limit threshold is a value for indicating a degree to which the electronic lock is jammed, where the pre-set lower limit threshold may be customized by a user, such as 0.3 or 0.5 cm or 1 cm, etc.

Since the absolute value is not greater than the pre-set upper limit threshold, it is indicated that the electronic lock is still in the jamming state although the electronic lock performs the lock jamming release operation. However, in the process of performing the lock jamming release operation by the electronic lock, according to the moving distance of the locking member, it is possible to characterize the extent to which the electronic lock is jammed.

For example, the pre-set upper limit threshold is 2 cm, and the pre-set lower limit threshold is 0.3 cm. After the electronic lock performs the lock jamming release operation, if the absolute value is 3 cm, it is indicated that the electronic lock has been released from the jamming state after performing the lock jamming release operation. If the absolute value is 1 cm, although the electronic lock is not released from the jamming state after performing the lock jamming release operation, it is helpful and effective to alternately perform the first operation and the second operation according to the pre-set number of cycles to release the electronic lock from the jamming state. If the absolute value is 0.1 cm or almost 0, not only the electronic lock has not been released from the jamming state after performing the lock jamming release operation, but also performing the first operation and the second operation alternately according to the pre-set number of cycles is ineffective to release the electronic lock from the jamming state, and the lock jamming release strategy needs to be adjusted.

As described above, the present embodiment can comprehensively determine the absolute value, the pre-set upper limit threshold and the pre-set lower limit threshold to select a correct and reliable strategy for controlling the electronic lock, which is advantageous in that the unlocking or locking can be performed quickly and reliably.

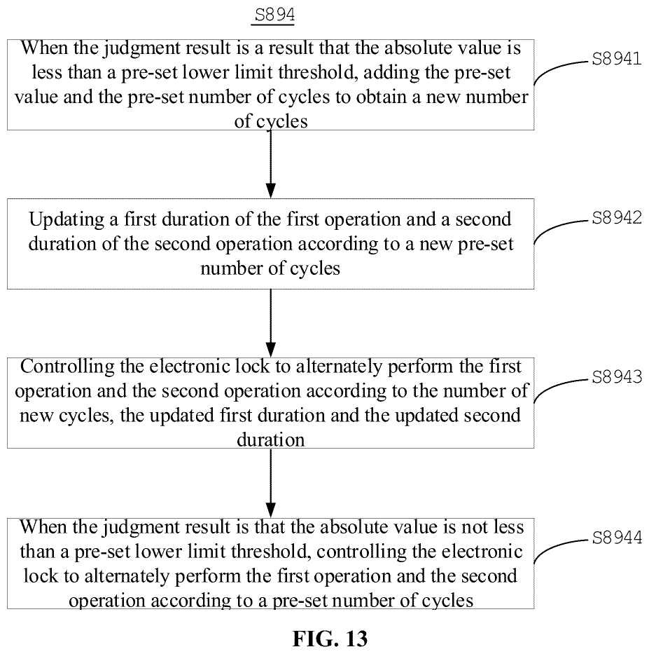

In some embodiments, when the electronic lock is controlled according to the judgment result, referring to FIG. 13, S894 includes:
S8941: if the judgment result is a result that the absolute value is less than a pre-set lower limit threshold, add the pre-set value and the pre-set number of cycles to obtain a new number of cycles.
S8942: Update a first duration of the first operation and a second duration of the second operation according to a new pre-set number of cycles.
S8943: Control the electronic lock to alternately perform the first operation and the second operation according to the number of new cycles, the updated first duration and the updated second duration.

In S8941, the pre-set value can be customized by the designer according to engineering experience, for example, the pre-set value is 1 or 2, etc. Since the absolute value is less than the pre-set lower limit threshold, it is indicated that alternately performing the first operation and the second operation according to the pre-set number of cycles is ineffective to release the electronic lock from the jamming state. Since the rotational force of the motor is relatively large each time the rotational direction is switched, and the greater the number of back and forth movements of the locking member, the more favorable is to release the electronic lock from the jamming state, when performing S8941, the charging pile adds the pre-set value and the pre-set number of cycles, for example, N′=N+1, to obtain a new number of cycles N′, and a pre-set number of cycles N′ before the new number of cycles N′ is updated. As the new number of cycles N′ becomes greater than the pre-set number of cycles N, the number of back and forth movements of the locking member is also increased to facilitate the disengagement of the electronic lock from the jamming state.

In S8942, as previously described, the first duration of the first operation is: t_{_p1}=T_{_p1}/N, the second duration of the second operation is: t_{_p2}=T_{_p2}/N, N′=N+1 is assigned and substituted into the above two equations to respectively obtain an updated first duration t′_{_p1}=T_{_p1}/N′, and an updated second duration t′_{_p2}=T_{_p2}/ N′.

In S8943, during each cycle, the charging pile controls the electronic lock to firstly perform a first operation of a first duration t′_{_p1}, and then perform a second operation of a second duration t′_{_p2}, so that a new number of cycles N′ is performed in total, and therefore after the first operation and the second operation of the new number of cycles are performed alternately, the total duration of the updated first operation is T_{_p1}, and the total duration of the second operation is T_{_p2}. It can be seen that the total duration of the first operation before the update is also T_{_p1} and the total duration of the second operation is T_{_p2}.

Therefore, even if the number of cycles is increased on the premise that the absolute value is less than the pre-set lower limit threshold, the total duration of the first operation before the update and the second operation after the update is constant, and the total duration of the second operation is constant, this method can increase the number of cycles within a limited time to improve the probability of releasing the electronic lock from the jamming state.

It can be understood that when the charging pile controls the electronic lock to alternately perform the first operation and the second operation according to the new number of cycles, the updated first duration and the updated second duration, and the absolute value is less than the pre-set lower limit threshold again, the charging pile takes the previously calculated new number of cycles as the pre-set number of cycles, adds the pre-set value and the pre-set number of cycles to obtain the new number of cycles, for example, the charging pile takes the previously calculated new number of cycles N′ as the pre-set number of cycles N, then obtains the new number of cycles N′ by taking N′=N+1, and finally, the charging pile returns to perform S8942 and S8943, and so on, continuously iterating until there is human factors intervention.

S8942: Update a first duration of the first operation and a second duration of the second operation according to a new pre-set number of cycles.

S8943: the electronic lock is controlled to alternately perform the first operation and the second operation according to the number of new cycles, the updated first duration and the updated second duration.

In some embodiments, when the electronic lock is controlled according to the judgment result, please continue to refer to FIG. 13, and S894 includes S8944 and S8943. If the judgment result is that the absolute value is not less than the pre-set lower limit threshold, the electronic lock is controlled to perform the first operation and the second operation alternately according to the pre-set number of cycles.

Since the absolute value is greater than or equal to the pre-set lower limit threshold, although the electronic lock is still in the jamming state after the lock jamming release operation is performed by the electronic lock, it is also described that alternately performing the first operation and the second operation according to the pre-set number of cycles is effective to releasing the electronic lock from the jamming state, only that the moving distance of the locking member has not yet reached the requirement that can be considered as the release of the electronic lock from the jamming state.

Therefore, the charging pile controls the electronic lock to alternately perform a first operation and a second operation according to a pre-set number of cycles, i.e., during each cycle, the charging pile controls the electronic lock to firstly perform a first operation of a first duration t_{_p1}, and then perform a second operation of a second duration t_{_p2}, for a total of the pre-set number of cycles N; in this way, without adjusting the original strategy, the locking member can be controlled to move step by step.

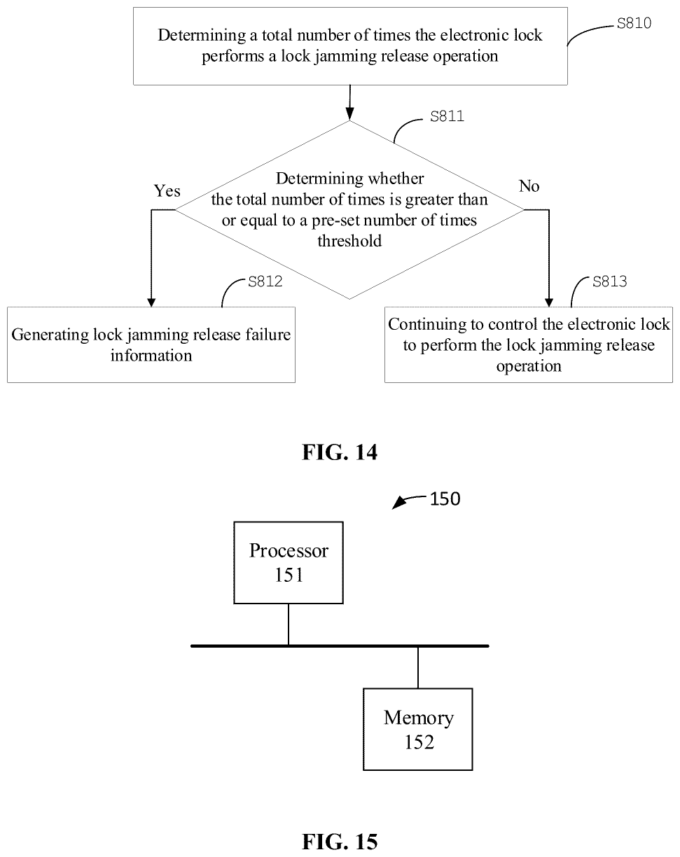

In some embodiments, referring to FIG. 14, the electronic-lock control method further includes:
S810: determining a total number of times the electronic lock performs a lock jamming release operation is determined.
S811: determining whether the total number of times is greater than or equal to a pre-set number of times threshold.
S812: when the total number of times is greater than or equal to the pre-set number of times threshold, generating the lock jamming release failure information.
S813: when the total number of times is less than the pre-set number of times threshold, continuing to control the electronic lock to perform the lock jamming release operation.

In S810, the total number of times is the number of times the electronic lock performs the lock jamming release operation. In some embodiments, when the charging pile receives a lock jamming command, the number of times is accumulated in the local log file.

In S811, the pre-set number of times threshold is customized by the designer according to engineering experience, for example, the pre-set number of times threshold is 3 or 5, etc.

In S812, the lock jamming release failure information is information for prompting the lock jamming release failure.

In some embodiments, the lock jamming release failure information is voice information, and the charging pile plays the lock jamming release failure information, or the charging pile sends the lock jamming release failure information to the cloud server, the cloud server forwards the lock jamming release failure information to the mobile terminal, and the mobile terminal plays the lock jamming release failure information.

In some embodiments, the lock jamming release failure information is text information, and the charging pile presents the lock jamming release failure information via a display screen, or the charging pile sends the lock jamming release failure information to the cloud server, and the cloud server forwards the lock jamming release failure information to the mobile terminal, and the mobile terminal presents the lock jamming release failure information.

Since the total number of times is greater than or equal to the pre-set number of times threshold, it is indicated that the electronic lock needs human intervention to disengage the jamming state.

In S813, since the total number of times is less than the pre-set number of times threshold, it is indicated that the electronic lock can continue to perform the lock jamming release operation without human intervention.

This embodiment can automatically monitor the lock jamming release to solve the problem timely, and can timely warn a user or a manager, and timely intervene in human factors for effective management.

It should be noted that in the above-mentioned embodiments, there is not necessarily a certain order between the above-mentioned steps, and a person skilled in the art would have been able to understand, according to the description of the embodiments in the present disclosure, that in different embodiments, the above-mentioned steps can be performed in different orders, i.e., can be performed in parallel, can be performed in exchange, etc.

Now referring to FIG. 15, FIG. is a schematic structural diagram showing a circuit of an electronic device according to an embodiment of the present disclosure, where the electronic device may be any suitable type of device. As shown in FIG. 15, the electronic device 150 includes one or more processors 151 and a memory 152. A processor 151 is exemplified in FIG. 15.

The processors 151 and the memory 152 may be connected via a bus or in other ways, and via a bus connection exemplified in FIG. 15.

The memory 152 serves as a non-volatile computer-readable storage medium for storing non-volatile software programs, non-volatile computer-executable programs, and modules, such as program instructions/modules, corresponding to the method for controlling electronic lock of a socket-type charging pile in embodiments of the present disclosure. The processor 151 implements the functions of the method for controlling electronic lock of a socket-type charging pile provided by the above-described embodiments by executing non-volatile software programs, instructions and modules stored in the memory 152.

The memory 152 may include high-speed random-access memory, and may also include non-volatile memory, such as at least one magnetic disk storage device, flash memory device, or other non-volatile solid state storage device. In some embodiments, the memory 152 may optionally include memories remotely located with respect to a processor 151, which may be connected to the processor 151 via a network. Embodiments of such networks include, but are not limited to, the Internet, Intranets, local area networks, mobile communication networks, and combinations thereof.

The program instructions/modules stored in the memory 152, when executed by the one or more processors 151, perform the method for controlling electronic lock of a socket-type charging pile in any of the method embodiments described above.

Embodiments of the present disclosure also provide a computer-readable storage medium having stored thereon computer-executable instructions that, when executed by one or more processors, such as processor 151 of FIG. 15, may cause the one or more processors to perform the method for controlling electronic lock of a socket-type charging pile in any of the method embodiments described above.

In a fifth aspect, embodiments of the present disclosure further provide a computer program product including a computer program stored on a computer readable storage medium computer program including program instructions which, when executed by an electronic device, cause the electronic device to perform the method for controlling electronic lock of a socket-type charging pile as described by any of the above.

The apparatus or device embodiments described above are merely illustrative, where the unit modules illustrated as separate components may or may not be physically separated, and the components shown as modular units may or may not be physical units, i.e. may be in one place, or may also be distributed over multiple network modular units. Some or all the modules may be selected according to actual needs to achieve the purpose of the solution of this embodiment.

From the above description of the embodiments, it will be clear to a person skilled in the art that the embodiments can be implemented by means of software plus a general-purpose hardware platform, but also by means of hardware. Based on such understanding, the technical solutions in essence or part contributing to the related art can be embodied in the form of a software product, which can be stored in a computer readable storage medium, such as ROM/RAM, magnetic disk, optical disk, etc., and includes several instructions for causing a computer device (which can be a personal computer, a server, or a network device, etc.) to perform the method according to various embodiments or some parts of embodiments.

Finally, it should be noted that: the above-mentioned embodiments are merely illustrative of the technical solution of the present disclosure, and do not limit same; the technical features in the above embodiments or in different embodiments may also be combined under the idea of the present disclosure, the steps may be implemented in any order, and there are many other variations of the different aspects of the present disclosure as above, which are not provided in the details for the sake of brevity; although the present disclosure has been described in detail Referring to the foregoing embodiments, a person skilled in the art will appreciate that: the technical solutions disclosed in the above-mentioned embodiments can still be amended, or some of the technical features thereof can be replaced by equivalents; however, these modifications or substitutions do not bring the essence of the corresponding technical solutions out of the scope of the technical solutions of the various an embodiment of the present disclosure.

The above description is only a particular embodiment of the present disclosure, but the scope of protection of the present disclosure is not limited thereto, and various changes or substitutions will readily occur to a person skilled in the art within the scope of the present disclosure, and these are intended to be within the scope of protection of the present disclosure. Therefore, the scope of protection of this application should be determined by the scope of protection of the claims.

What is claimed is:

1. A method for controlling an electronic lock of a socket-type charging pile, the method comprising:
acquiring a lock jamming command, the lock jamming command being used for indicating that the electronic lock is in a jamming state, wherein the socket-type charging pile is provided with a socket, the electronic lock is installed on the socket for locking or unlocking a charging gun that is inserted into the socket; and
controlling the electronic lock to perform a lock jamming release operation according to the lock jamming command.

2. The method according to claim 1, wherein the controlling the electronic lock to perform the lock jamming release operation according to the lock jamming command comprises:
controlling the electronic lock to perform a first operation and a second operation alternately according to a pre-set number of cycles provided by the lock jamming command,
wherein when the electronic lock is in a lock jamming state, the first operation is an unlocking operation, and the second operation is a locking operation, and
wherein when the electronic lock is in an unlock jamming state, the first operation is a locking operation, and the second operation is an unlocking operation.

3. The method according to claim 2, wherein the electronic lock is provided with a locking member, and wherein when the locking member performs the first operation and the second operation at the same speed, a first duration of the first operation is shorter than a second duration of the second operation.

4. The method according to claim 3, after performing the lock jamming release operation, the method further comprising:
determining whether the locking member is at a designated position;
in response to determining that the locking member is at the designated position, generating lock jamming release success information; and
in response to determining that the locking member is not at the designated position, controlling the electronic lock to perform the second operation for a specified duration, wherein the specified duration is greater than or equal to a standard duration required for the electronic lock to normally lock or unlock the charging gun.

5. The method according to claim 4, wherein when the locking member is not at the designated position, before performing the second operation for the specified duration, the method further comprising:
controlling the electronic lock to perform the first operation for a pre-set duration.

6. The method according to claim 3, further comprising:
determining a first moving distance and a second moving distance, wherein the first moving distance is a moving distance of the locking member before the first operation is performed for a first time, and the second moving distance is a moving distance of the locking member after the second operation is performed for a last time;
calculating an absolute value of a difference between the first moving distance and the second moving distance; and
controlling the electronic lock according to the absolute value and a pre-set upper limit threshold.

7. The method according to claim 6, wherein when the lock jamming release operation is performed, the first duration of the first operation is: t_{_p1}=T_{_p1}/N, the second duration of the second operation is: t_{_p2}=T_{_p2}/N, wherein T_{_p1} is less than T_{_p2}, T_{_p1} and T_{_p2} are pre-set time, and N is the pre-set number of cycles.

8. The method according to claim 7, wherein the controlling the electronic lock according to the absolute value and the pre-set upper limit threshold comprises:
determining whether the absolute value is greater than the pre-set upper limit threshold;
in response to determining that the absolute value is greater than the pre-set upper limit threshold, controlling the electronic lock to perform the second operation for a specified duration; and
in response to determining that the absolute value is not greater than the pre-set upper limit threshold, determining a judgment result that indicates whether the absolute value is less than a pre-set lower limit threshold, and controlling the electronic lock according to the judgment result.

9. The method according to claim 8, wherein the controlling the electronic lock according to the judgment result comprises:
in response to determining that the judgment result indicates the absolute value is less than the pre-set lower limit threshold, adding the pre-set value and the pre-set number of cycles to obtain a new number of cycles;
updating a first duration of the first operation and a second duration of the second operation according to the new number of cycles; and
controlling the electronic lock to perform the first operation and the second operation alternately according to the number of new cycles, the updated first duration, and the updated second duration.

10. The method according to claim 8, wherein the controlling the electronic lock according to the judgment result comprises:
in response to determining that the judgment result indicates the absolute value is not less than the pre-set lower limit threshold, controlling the electronic lock to perform the first operation and the second operation alternately according to a pre-set number of cycles.

11. The method according to claim 1, further comprising:
determining a total number of times the electronic lock performs the lock jamming release operation;
determining whether the total number of times is greater than or equal to a pre-set number of times threshold; and
in response to determining that the total number of times is greater than or equal to the pre-set number of times threshold, generating the lock jamming release failure information.

12. A socket-type charging pile, comprising:
a pile body;
a socket installed on the pile body for inserting a charging gun;
an electronic lock installed on the socket; and
a controller connected to the electronic lock for performing acts comprising acquiring a lock jamming command, the lock jamming command being used for indicating that the electronic lock is in a jamming state; and
controlling the electronic lock to perform a lock jamming release operation according to the lock jamming command.

13. The socket-type charging pile according to claim 12, wherein the electronic lock comprises a motor, a transmission mechanism and a locking member, and the controller is connected to the motor, the motor is connected to the transmission mechanism, and the transmission mechanism is connected to the locking member for driving the locking member to lock or unlock the charging gun.

14. The socket-type charging pile according to claim 13, wherein the electronic lock further comprises a travel sensor coupled to the controller for detecting a moving distance of the locking member.

15. A charging apparatus, comprising: a socket-type charging pile,
wherein the socket-type charging pile comprises:
a pile body;
a socket installed on the pile body for inserting a charging gun;
an electronic lock installed on the socket;
a controller connected to the electronic lock for performing acts comprising:
acquiring a lock jamming command, the lock jamming command being used for indicating that the electronic lock is in a jamming state; and
controlling the electronic lock to perform a lock jamming release operation according to the lock jamming command; and
a charging gun comprising a gun body, a pile body plug and a vehicle plug, wherein the pile body plug and the vehicle plug are respectively installed on two ends of the gun body, and the electronic lock is used for locking or unlocking the pile body plug.

16. The method according to claim 2, further comprising:
determining a total number of times the electronic lock performs the lock jamming release operation;
determining whether the total number of times is greater than or equal to a pre-set number of times threshold; and
in response to determining that the total number of times is greater than or equal to the pre-set number of times threshold, generating the lock jamming release failure information.

17. The method according to claim 3, further comprising:
determining a total number of times the electronic lock performs the lock jamming release operation;
determining whether the total number of times is greater than or equal to a pre-set number of times threshold; and
in response to determining that the total number of times is greater than or equal to the pre-set number of times threshold, generating the lock jamming release failure information.

18. The method according to claim 4, further comprising:
determining a total number of times the electronic lock performs the lock jamming release operation;
determining whether the total number of times is greater than or equal to a pre-set number of times threshold; and
in response to determining that the total number of times is greater than or equal to the pre-set number of times threshold, generating the lock jamming release failure information.

19. The method according to claim 5, further comprising:
determining a total number of times the electronic lock performs the lock jamming release operation;
determining whether the total number of times is greater than or equal to a pre-set number of times threshold; and
in response to determining that the total number of times is greater than or equal to the pre-set number of times threshold, generating the lock jamming release failure information.

20. The method according to claim 6, further comprising:
determining a total number of times the electronic lock performs the lock jamming release operation;
determining whether the total number of times is greater than or equal to a pre-set number of times threshold; and
in response to determining that the total number of times is greater than or equal to the pre-set number of times threshold, generating the lock jamming release failure information.
